(19) United States
(12) Patent Application Publication
(10) Pub. No.: US 2008/0217106 A1
(43) Pub. Date: Sep. 11, 2008

(54) Metering device for a lubricant dispenser

(75) Inventors: Egon Eisenbacher, Karlstadt (DE); Thomas Hildenbrand, Bad Bruckenau (DE)

Correspondence Address: COLLARD & ROE, P.C., 1077 NORTHERN BOULEVARD, ROSLYN, NY, 11576, US

(73) Assignee: perma-tec GmbH & Co. KG

(21) Appl. No.: 12/070,819

(22) Filed: Feb. 21, 2008

(30) Foreign Application Priority Data
Mar. 6, 2007 (DE) 10 2007 011 192.6

(51) Int. Cl. F16N 27/00; B67D 5/16; F16N 7/36; F16N 13/10

(52) U.S. Cl. 184/7.4; 222/71; 184/27.1

(57) ABSTRACT

A metering device for a lubricant dispenser has an inflow opening and at least two outflow openings for dividing up the amounts of lubricant being conveyed, and has a slide inserted into a housing of the metering device so as to move lengthwise, which slide has an axial bore on the inflow side. The outflow openings are connected to the axial bore of the slide on the inflow side by way of a displacement chamber, in each instance. The displacement chambers are hydraulically separated from one another by kickback valves. A forward stroke of the slide brings about a reduction in volume of the displacement chambers and flow of the lubricant out of the outflow openings. A backward stroke of the slide brings about an increase in volume of the displacement chambers and follow-up flow of the lubricant through the kickback valves.

### CROSS-REFERENCE TO RELATED APPLICATIONS

Applicants claim priority under 35 U.S.C. §119 of German Application No. 10 2007 011 192.6 filed Mar. 6, 2007.

### BACKGROUND OF THE INVENTION

1. Field of the Invention

The present invention relates to a metering device for a lubricant dispenser, having an inflow opening and at least two outflow openings for dividing up the amounts of lubricant being conveyed, and having a slide inserted into a housing of the metering device so as to move lengthwise. The slide has an axial bore on the inflow side. The metering device allows supplying two or more lubrication points with lubricant, using only one lubricant dispenser.

2. The Prior Art

For distributing lubricant from a lubricant dispenser onto several lubrication points, simple branchings are not suitable, because different, undefined lubrication can occur at the different lubrication points due to different resistances, particularly flow resistance, component friction resistance, or other counter-pressure resistance. A metering device having the characteristics described initially, which allows division of lubricant, is known from the reference DE 101 48 455 A1. The metering device can be connected with a lubricant dispenser as an outlet module, whereby the conveyance slide can be pressed into position by a pump element of the lubricant dispenser, counter to a reset spring. The conveyance slide is disposed in a housing as a slide guide, so as to move lengthwise, whereby two radial outflow openings, offset in the longitudinal direction, are provided in the housing.

In the case of a forward stroke movement of the conveyance slide, the lubricant can at first flow into a first outflow opening, through an opening at the end of the conveyance slide, while a second outflow opening is closed off by the conveyance slide. During the stroke movement, the first outflow opening is subsequently closed off by the conveyance slide, and lubricant can flow into the second outflow opening through a radial bore and a ring groove of the conveyance slide. The partial volumes of the lubricant that flow through the first and the second outflow opening are influenced via the position of the slide. In the case of a forward stroke of the slide, however, undesirable pressure peaks can occur because of the changing outflow cross-sections. If both outflow openings are opened at the same time, at least partially, the division of the lubricant amounts is undefined, and an overflow can also occur between the outflow openings. The disadvantages resulting from alternating opening of the outflow openings are further reinforced by production inaccuracies.

### SUMMARY OF THE INVENTION

With this background, it is an object of the invention to provide a metering device for a lubricant dispenser, having the characteristics described initially, which reliably allows a defined division of the conveyed lubricant amounts to at least two outflow openings.

Proceeding from a metering device having the characteristics described initially, these and other objects are achieved, according to the invention, by having the outflow openings connected to the axial bore of the slide on the inflow side by way of a displacement chamber, in each instance, and by having the displacement chambers hydraulically separated from one another via kickback valves. A forward stroke of the slide brings about a reduction in volume of the displacement chambers and flow of the lubricant out of the outflow openings. A backward stroke of the slide brings about an increase in volume of the displacement chambers and follow-up flow of the lubricant through the kickback valves. According to the invention, defined volumes of the lubricant are dispensed through the outflow openings at the same time during a forward stroke movement, due to the configuration of the displacement chambers. The increase in volume of the displacement chambers, which are filled with lubricant again by way of the kickback valves, also takes place at the same time for all the displacement chambers, in the case of a backward stroke.

The amount of lubricant conveyed per stroke movement is determined by the change in volume of the displacement chambers. In this connection, the changes in volume of the displacement chambers assigned to different outflow openings, in each instance, can be the same or also different for all the displacement chambers. The ratio of the lubricant amounts exiting at the outflow openings can be variably adjusted via dimensioning the displacement chambers. In a normal case, dispensing of the lubricant via a metering device attached to a lubricant dispenser takes place over a long period of time. A pause is provided between two lubrication intervals, during which at least one stroke movement of the slide is performed. Fundamentally, the amount of lubricant dispensed by the metering device is also dependent on the stroke path of the slide, so that the amount of lubricant dispensed can be varied via changing the stroke path, depending on the drive of the slide.

Preferably, an additional kickback valve may be disposed in the region of the outflow openings, in each instance, in order to prevent reverse flow of the lubricant pressed out previously when a backward stroke occurs.

One displacement chamber can be formed in a slide guide of the slide and follow an outflow-side end of the slide, in the longitudinal direction. The kickback valve assigned to this displacement chamber is disposed in the slide. The outflow opening can follow in the longitudinal direction, for example, or can follow the displacement chamber laterally. In addition or alternatively, it can also be provided that at least one of the displacement chambers is formed by the slide guide and a step of the slide. The volume of the ring space that is formed by the step of the conveyance slide and a corresponding step of the slide guide is changed by means of the stroke movement of the slide, and the lubricant is pressed out of the related outflow opening. The kickback valve assigned to the displacement chamber configured as a ring chamber is preferably disposed laterally offset relative to the slide and is connected with the slide guide by way of flow channels that run radially. In most cases, the slide has at least one related radial opening.

In a first embodiment of the invention, two outflow openings are provided, whereby a first displacement chamber is configured as a ring chamber, as described, and whereby a second displacement chamber follows the outflow-side end of the slide in the longitudinal direction. The kickback valve disposed between the first displacement chamber and the axial bore of the slide is disposed opposite the related outflow opening, thereby making it possible to achieve a particularly compact structure. The kickback valve is connected with the slide housing by means of flow channels that run radially, for example, whereby the kickback valve described can also be inserted into a housing that forms the slide guide via a longitudinal bore, in particularly simple manner.

In a second embodiment of the invention, multiple displacement chambers can also be provided around the circumference of the metering device, which chambers are formed by the slide guide and a step of the slide, in each instance, whereby a kickback valve and an outflow opening are assigned to each of these displacement chambers. Optionally, another displacement chamber can also be provided, in addition, at the outflow-side end of the slide.

In the embodiments described above, the volume of the displacement chambers is directly reduced by the slide itself in the case of a forward stroke. In an alternative, particularly preferred embodiment of the invention, the slide acts on at least two secondary slides during a forward stroke, which are disposed in a secondary slide guide formed in the housing, in each instance. The lubricant that flows in through the slide is distributed to the secondary slides, in this connection. The design of the individual components of the metering device and, in particular, the design of the slide can be greatly simplified by means of arranging the additional secondary slides. Even though a further secondary distribution in accordance with the configuration of the slide as described above is fundamentally possible with regard to the secondary slides, in a preferred further embodiment, precisely one of the displacement chambers is assigned to each secondary slide. In the embodiment, the displacement chambers can be formed at the outflow-side ends of the secondary slides, in the related secondary slide guides, in particularly simple manner in terms of design. The kickback valves, which prevent reverse flow of the lubricant out of the displacement chambers through axial bores of the secondary slides, are disposed in the related secondary slides.

The slide can be rigidly coupled with a drive, but preferably, the forward stroke movement or the backward stroke movement takes place counter to the force of at least one reset spring, so that only pulling or pressing forces have to be transferred to the slide by the drive. If, in accordance with the further embodiment of the metering device, the slide acts on two secondary slides disposed in the housing, as described above, it is practical if a reset spring is disposed on each of the secondary slides, in order to move the secondary slides and thereby also the slide itself in the backward direction. Assignment of the forward direction and backward direction results from the method of function of the metering device, as described.

In order to allow easy assembly of the metering device and a simple configuration of the individual components, the housing can be composed of at least two housing parts. The individual components of the metering device, in other words the slide, the kickback valves, and, if they are provided, also the secondary slides, and the at least one reset spring, can be inserted into the individual housing parts, during assembly. These parts are then held in their intended position after the housing parts have been joined together.

The metering device can be integrated into a lubricant dispenser as an outlet device; however, a configuration of the metering device in which the device can be connected to a lubricant dispenser, in modular manner, is particularly preferred. In the case of such a configuration, the lubricant dispenser can be combined with a metering device according to the invention that has two or more outflow openings. In accordance with the requirements, metering devices according to the invention can be kept available with a different number of outflow openings, and for uniform or non-uniform distribution of the lubricant amounts to the outflow openings. The slide of the metering device can be moved in the forward direction by a tappet of the lubricant dispenser, for example.

A particularly advantageous lubricant dispenser, which can be combined with different embodiments of the metering device according to the invention, is known from the reference EP 1 523 637 B1. The lubricant dispenser with the metering device connected with it has a lubricant supply container, a piston disposed on a threaded spindle within the lubricant supply container, and a drive head having a drive shaft connected with the threaded spindle, and an electromechanical drive for activating the drive shaft. The drive shaft contains a lubricant passage channel, which opens into a lubricant supply chamber of the lubricant supply container. A tappet is set into the lubricant passage channel, which tappet has an axial bore having a kickback valve on the inflow side and a tappet head disposed so as not to rotate, and acted on by a pressure spring. The tappet head lies against a control surface of the drive shaft under the effect of the pressure spring. The control surface and the related contact surface of the tappet head are configured as a motion link surface, which bring about stroke movements of the tappet when a rotational movement of the control surface occurs, which movements convey the lubricant through the axial bore of the tappet to the metering device according to the invention, and the metering device distributes the conveyed lubricant amount to at least two outflow openings. The metering device according to the invention; however, can also be combined with any other lubricant dispensers having a different structure, without restrictions. It is particularly advantageous that the metering device itself produces a pump effect during a stroke movement.

In the case of a metering device that can be connected to a lubricant dispenser as an outlet module, or is integrated into a lubricant dispenser, the slide can be structured as a section of a tappet of the metering device, which tappet is structured in one piece. If, as described above, two secondary slides are provided in the housing of the metering device, in this connection, the slide, as a section of the tappet, acts directly on the two secondary slides during a forward stroke.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1a shows a metering device for a lubricant dispenser, according to the invention, during a forward stroke of a slide disposed in a slide guide;

FIG. 1b shows the metering device according to FIG. 1, during a backward stroke of the slide;

FIG. 2 shows the metering device according to FIGS. 1a and 1b, connected to a lubricant dispenser as an outlet module;

FIG. 3 is a perspective view of an alternative embodiment of the metering device according to the invention, in a perspective view;

FIG. 4a is a longitudinal section through the metering device according to FIG. 3, along the outflow openings; and

FIG. 4b is a longitudinal section through the metering device according to FIG. 3, along the housing screws shown in FIG. 3.

### DETAILED DESCRIPTION OF PREFERRED EMBODIMENTS

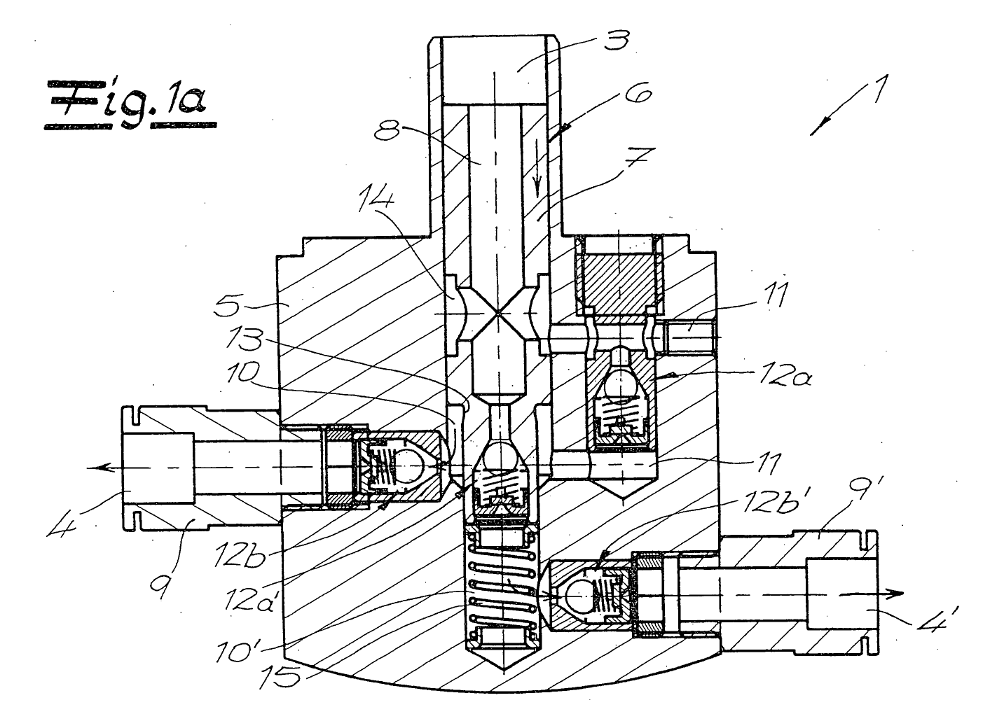

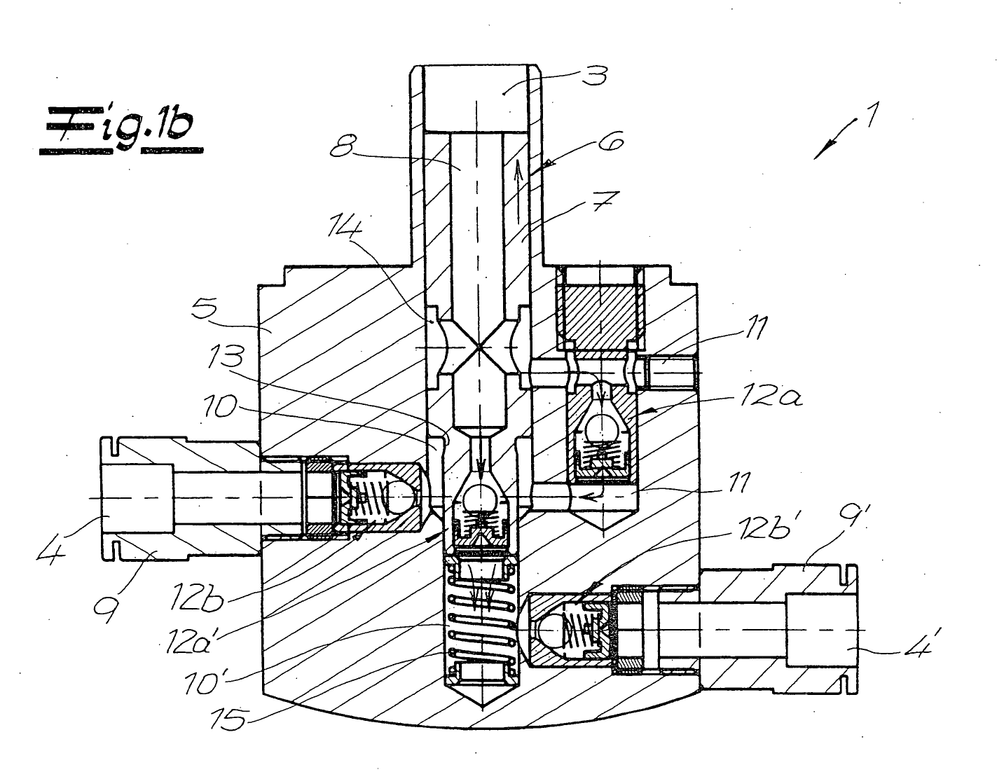

Referring now in detail to the drawings and in particular, FIG. 1a shows a metering device 1 for a lubricant dispenser 2, according to the invention, having an inflow opening 3 and two outflow openings 4, 4′ for dividing up the conveyed lubricant amounts. A slide guide 6 for a slide 7 disposed to be displaceable in the lengthwise direction, which slide has an axial bore 8 on the inflow side, is formed in a housing 5 of metering device 1. Outflow openings 4, 4′ are formed in connectors 9, 9′, in each instance, to which lubricant lines can be connected. Outflow openings 4, 4′ are connected with axial bore 8 of slide 7 by way of a displacement chamber 10, 10′ and flow channels 11, in each instance, whereby the displacement chambers 10, 10′ are hydraulically separated from one another via kickback valves 12a, 12a′ on the inflow side.

The first displacement chamber 10 is formed by slide guide 6 and a step of slide 7, whereby related kickback valve 12a is disposed between first displacement chamber 10 and axial bore 8 of slide 7 on the inflow side, offset laterally from slide 7, and whereby kickback valve 12a is connected to slide guide 6 by way of flow channels 11 that run radially. Slide 7 has at least one related radial opening 14.

The second displacement chamber 10′ is formed in slide guide 6 and follows an outflow-side end of slide 7, in the longitudinal direction, whereby kickback valve 12a′ assigned to second displacement chamber 10′ is disposed in slide 7. In the case of a forward stroke of slide 7 counter to the force of a reset spring 15, a reduction in volume of two displacement chambers 10, 10′ occurs, whereby the lubricant cannot flow back to axial bore 8 of slide 7 because of kickback valves 12a, 12a′, and, at the same time, flows out of outflow openings 4, 4′. When the lubricant flows out, other kickback valves 12b, 12b′ on the outflow side, which are disposed in the region of outflow openings 4, 4′, are opened.

FIG. 1b shows the metering device in the case of a backward stroke of slide 7, whereby kickback valves 12b, 12b′ on the outflow side are closed, and prevent a reverse flow of the lubricant previously pressed out of outflow openings 4, 4′, so that the lubricant continues to flow into displacement chambers 10, 10′ through kickback valves 12a, 12a′ on the inflow side, in the case of a backward stroke.

As can be seen in FIGS. 1a and 1b, a clearly defined amount of lubricant is conveyed through every outflow opening 4, 4′ during a stroke movement, in particularly advantageous manner, which amount corresponds to the changeable volume of the corresponding displacement chamber 10, 10′. The lubricant amount dispensed during a forward stroke can be precisely adjusted for each of outflow openings 4, 4′ via the configuration of displacement chambers 10, 10′. In particular, the same or different amounts of lubricant may be dispensed at two outlet openings 4, 4′.

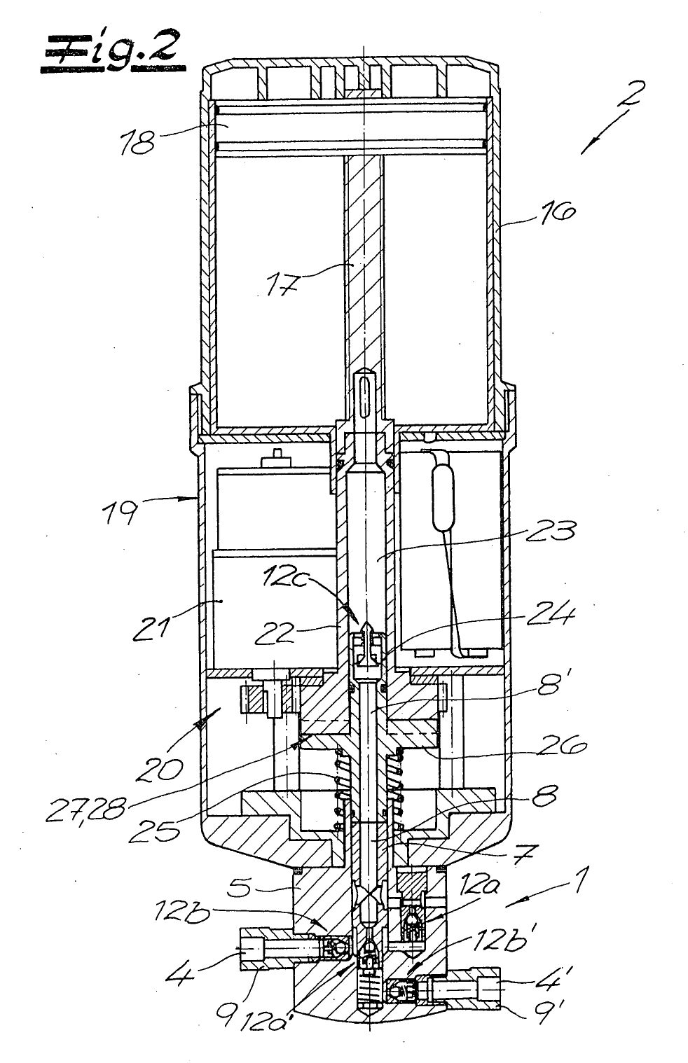

FIG. 2 shows the metering device 1 according to the invention, which is connected to a lubricant dispenser 2 for viscous lubricants, particularly lubrication greases, as an outlet module. Lubricant dispenser 2 has a lubricant supply container 16 having a piston 18 disposed on a threaded spindle 17, and a drive head 19 having an electromechanical drive 20. Threaded spindle 17 is releasably connected with a drive shaft 22 of drive head 19 driven by an electric motor 21. Drive shaft 22 contains a lubricant passage channel 23, which opens into the lubricant supply chamber of lubricant supply container 16. A tappet 24 is set into lubricant passage channel 23, which tappet has an axial bore 8′ having a kickback valve 12c on the inflow side and a tappet head 26 disposed in drive head 19 so as not to rotate, and supported on a pressure spring 25, so as to move axially. Tappet head 26 lies against a control surface 27 of drive shaft 22 under the effect of pressure spring 25. Control surface 27 and the related contact surface 28 of tappet head 26 are configured as motion link surfaces, which bring about tappet strokes in the case of a rotational movement of control surface 27. Slide 7 of metering device 1 connected with lubricant dispenser 2 as a module is pressed against tappet 24 by reset spring 15, whereby slide 7 can be pressed down in the forward stroke direction by tappet 24 of the lubricant dispenser, counter to the force of the reset spring 15. In this connection, axial bore 8 of slide 7 directly follows axial bore 8′ of tappet 24.

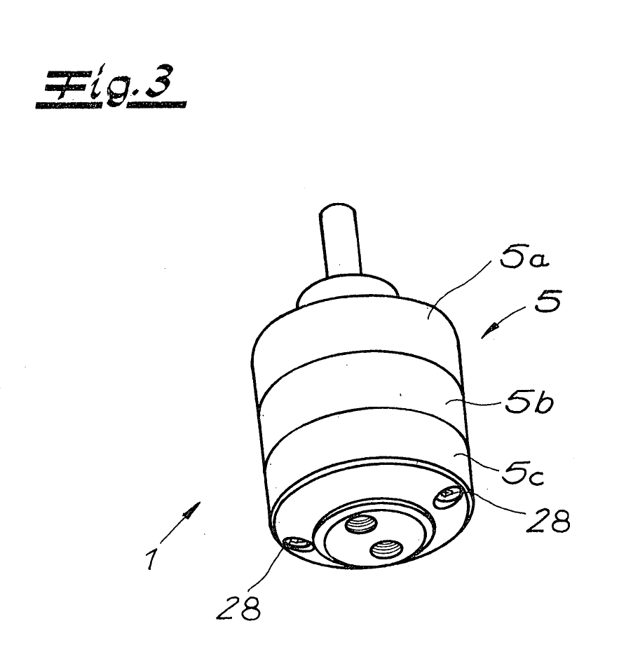

An alternative embodiment of the metering device 1 is shown in FIG. 3. Housing 5 is composed of three housing parts 5a, 5b, 5c, which are connected via housing screws 28. Lubricant lines can be directly screwed into outflow openings 4, 4′ made in the bottom side of lowermost housing part 5c. Alternatively, however, additional connectors 9, 9′ for accommodating lubricant lines can also be provided, as shown in FIGS. 1a to 2. Connectors 9, 9′ may be provided with a quick-connect fitting, for example. Slide 7 extends out of uppermost housing part 5a at the top of the metering device.

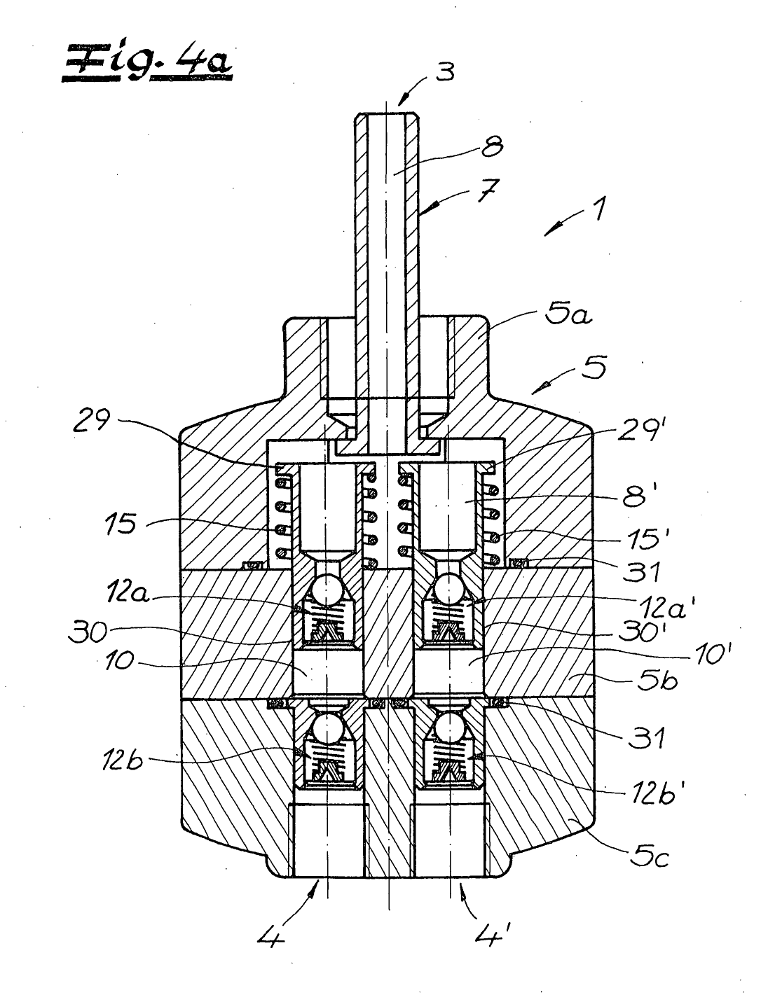

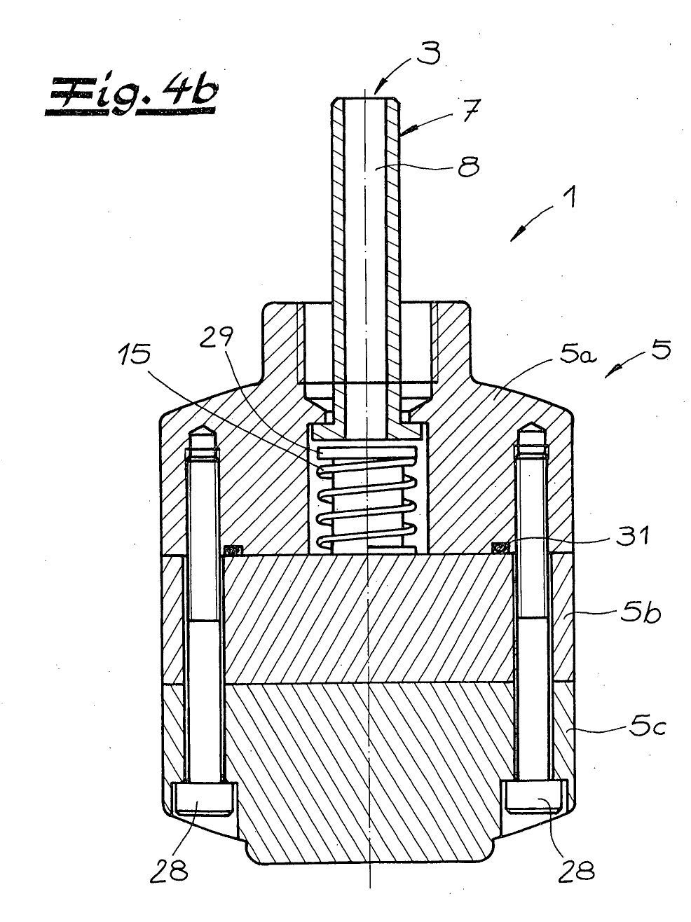

FIG. 4a shows the metering device 1 according to FIG. 3 in a longitudinal section along outflow openings 4, 4′. Slide 7, which is inserted into uppermost housing part 5a, acts on two secondary slides 29, 29′ during a forward stroke. Secondary slides 29, 29′ have an axial bore 8′, 8′, in each instance, and are disposed in a secondary slide guide 30, 30′ formed in the center housing part 5b, in each instance. In the case of a forward stroke of slide 7, kickback valves 12a, 12a′ integrated into secondary slides 29, 29′ are closed, so that the lubricant is pressed out of displacement chambers 10, 10′ formed in the secondary slide guides 30, 30′ via kickback valves 12b, 12b′ on the outflow side. The backward movement of slide 7 takes place via reset springs 15, 15′, which act on slide 7 by way of one of secondary slides 29, 29′, in each instance. During the backward stroke, inflow-side kickback valves 12a, 12a′ open, so that displacement chambers 10, 10′ are again filled with a defined amount of lubricant. In this connection, reverse flow of lubricant out of outflow openings 4, 4′ is prevented by means of closed outflow-side kickback valves 12b, 12b′.

During assembly of metering device 1, slide 7, secondary slides 29, 29′ having reset springs 15, 15′ and inflow-side kickback valves 12a, 12a′ and outflow-side kickback valves 12b, 12b′ can be inserted into related housing parts 5a, 5b, 5c in particularly simple manner, whereby the components described are held in their functional position after housing parts 5a, 5b, 5c are joined together. It is practical if seals 31 are provided to form a seal between housing parts 5a, 5b, 5c.

It can be derived from FIG. 4b that housing parts 5a, 5b, 5c are held together by housing screws 28. For maintenance or cleaning of metering device 1, two housing screws 28 merely have to be loosened in order to break housing 5 down into its housing parts 5a, 5b, 5c.

Accordingly, although only a few embodiments of the present invention have been shown and described, it will become apparent that many changes and modifications may be made thereunto without departing from the spirit and scope of the invention.

What is being claimed is:

1. A metering device for a lubricant dispenser comprising:
(a) a housing;
(b) an inflow opening;
(c) at least first and second outflow openings for dividing up amounts of lubricant being conveyed;
(d) a slide inserted into the housing so as to move lengthwise, said slide having an axial bore on an inflow side;
(e) first and second displacement chambers; and
(f) first and second kickback valves;
wherein the first and second outflow openings are connected to the axial bore on the slide on the inflow side by way of the first and second displacement chambers, respectively;
wherein the first and second displacement chambers are hydraulically separated from one another by the first and second kickback valves;
wherein a forward stroke of the slide brings about a reduction in volume of the first and second displacement chambers and flow of the lubricant out of the first and second outflow openings; and
wherein a backward stroke of the slide brings about an increase in volume of the first and second displacement chambers and follow-up flow of the lubricant through the first and second kickback valves.

2. The metering device according to claim 1, further comprising third and fourth kickback valves disposed near the first and second outflow openings, respectively.

3. The metering device according to claim 1, wherein the forward stroke movement of the slide takes place counter to a force of at least one reset spring.

4. The metering device according to claim 1, wherein at least one of the first and second displacement chambers is formed by a slide guide in the housing and a step of the slide.

5. The metering device according to claim 4, wherein the first kickback valve is assigned to the first displacement chamber formed between the slide guide and the step of the slide, and is disposed offset laterally from the slide, wherein the first kickback valve is connected to the slide guide by way of flow channels that run radially, and wherein the slide has at least one related radial opening.

6. The metering device according to claim 1, wherein one of the first and second displacement chambers is formed in a slide guide and follows an outflow-side end of the slide in a longitudinal direction, wherein the second kickback valve is assigned to the second displacement chamber and is disposed in the slide.

7. The metering device according to claim 1, further comprising at least first and second secondary slides respectively disposed in first and second secondary slide guides formed in the housing, wherein during a forward stroke, the slide acts on the first and second secondary slides.

8. The metering device according to claim 7, wherein each secondary slide is assigned to precisely one of the displacement chambers, the displacement chambers being formed in the secondary slide guideson an outflow side.

9. The metering device according to claim 7, wherein the first and second kickback valves that hydraulically separate the first and second displacement chambers from one another are respectively disposed in the first and second secondary slides.

10. The metering device according to claim 1, wherein the housing comprises at least two housing parts.

11. A metering device and lubricant dispenser assembly comprising:
(a) a lubricant dispenser comprising a tappet; and
(b) a metering device connectable with the lubricant device as an outlet module, said metering device comprising a housing, an inflow opening, at least first and second outflow openings for dividing up amounts of lubricant being conveyed, a slide inserted into the housing so as to move lengthwise, said slide having an axial bore on an inflow side, first and second displacement chambers, and first and second kickback valves;
wherein the first and second outflow openings are connected to the axial bore on the slide on the inflow side by way of the first and second displacement chambers respectively;
wherein the first and second displacement chambers are hydraulically separated from one another by the first and second kickback valves;
wherein a forward stroke of the slide brings about a reduction in volume of the first and second displacement chambers and flow of the lubricant out of the first and second outflow openings;
wherein a backward stroke of the slide brings about an increase in volume of the first and second displacement chambers and follow-up flow of the lubricant through the first and second kickback valves; and
wherein the slide is movable in the forward stroke direction by the tappet of the lubricant dispenser.

12. A metering device and lubricant dispenser assembly comprising:
(a) a lubricant dispenser comprising a movably guided tappet; and
(b) a metering device integrated into the lubricant device, said metering device comprising a housing, an inflow opening, at least first and second outflow openings for dividing up amounts of lubricant being conveyed, a slide inserted into the housing so as to move lengthwise, said slide having an axial bore on an inflow side, first and second displacement chambers, and first and second kickback valves;
wherein the first and second outflow openings are connected to the axial bore on the slide on the inflow side by way of the first and second displacement chambers respectively;
wherein the first and second displacement chambers are hydrualically separated from one another by the first and second kickback valves;
wherein a forward stroke of the slide brings about a reduction in volume of the first and second displacement chambers and flow of the lubricant out of the first and second outflow openings; and
wherein a backward stroke of the slide brings about an increase in volume of the first and second displacement chambers and follow-up flow of the lubricant through the first and second kickback valves.

13. The metering device and lubricant dispenser assembly according to claim 11, wherein the slide is formed as a section of the tappet structured in one piece.

14. The metering device and lubricant dispenser assembly according to claim 13, wherein the slide directly acts on two secondary slides during the forward stroke.
